(19) United States
(12) Patent Application Publication
(10) Pub. No.: US 2019/0031231 A1
(43) Pub. Date: Jan. 31, 2019

(54) TIRE LOAD ESTIMATION USING STEERING SYSTEM SIGNALS

(71) Applicant: STEERING SOLUTIONS IP HOLDING CORPORATION, Saginaw, MI (US)

(72) Inventor: Mariam Swetha George, Midland, MI (US)

(21) Appl. No.: 15/661,210

(22) Filed: Jul. 27, 2017

(51) Int. Cl. B62D 5/04; B62D 6/08; B62D 6/02; B62D 6/00

(52) U.S. Cl. CPC B62D 5/0481; B62D 6/08; B62D 5/0463; B62D 6/008; B62D 6/02

(57) ABSTRACT

Technical solutions are described for a power steering system of a vehicle to estimate tire load. An example control system of a power steering includes a control module to receive sensor data and control the power steering system. For example, the control module determines an estimated friction torque of a rack connected to the steering system, compute an input torque to the rack, the input torque being a sum of the estimated friction torque, a handwheel torque, and a motor torque, and further determine a rack position estimate based on the input torque, a handwheel angle, and a vehicle speed. Further, in response to the rack position estimate being computed, the control module computes a tire load estimate from the rack position estimate.

### BACKGROUND

The present application generally relates to steering systems of a vehicle, such as an electric power steering (EPS) systems, and more particularly to facilitating steering systems to compute tire load estimates in real time.

Typically, when operating a vehicle, such as a car, an operator that steers the vehicle has at least two responsibilities, one to follow an intended path, and a second to compensate for road disturbances. For the latter task, the driver compensates, for example, by counteracting at a steering wheel of the vehicle, the counteraction being adequate disturbance attenuation in response to the road disturbance. However, such kind of road disturbance typically comes as a surprise to the driver. It is desirable that the driver be responsible only for the task of path following, and accordingly to decouple the driver from the road disturbances. However such decoupling mandates a estimating tire load in a manner that is robust to road surface friction and vehicle velocity. Therefore, estimating tire load becomes vital to vehicle dynamics control. Moreover, knowledge of tire load can be used to determine useful information of road surface friction, and for closed loop torque control of a steering system of the vehicle. Further, the tire load estimation can be used in steer-by-wire (SbW) type steering systems, in addition to the disturbance rejection estimation in the steering system.

Accordingly, it is desirable to for a steering system to perform real time estimation of tire load.

### SUMMARY

One or more embodiments are described for a power steering system of a vehicle that estimates tire load. An example control system of the power steering includes a control module to receive sensor data and control the power steering system. For example, the control module determines an estimated friction torque of a rack connected to the steering system, compute an input torque to the rack, the input torque being a sum of the estimated friction torque, a handwheel torque, and a motor torque, and further determine a rack position estimate based on the input torque, a handwheel angle, and a vehicle speed. Further, in response to the rack position estimate being within a predetermined threshold of a measured rack position, the control module computes a tire load estimate from the rack position estimate.

Further, according to one or more embodiments a computer-implemented method for determining a tire load estimate by a steering system of a vehicle includes

receiving, by a control module, a handwheel torque from an operator of the steering system. The method further includes computing, by the control module, a motor torque to assist in overcoming an estimated rack force. The method also includes computing, by the control module, a friction torque estimate for the steering system. Further, the method includes computing, by the control module, a rack position estimate based on a sum of the handwheel torque, the motor torque, and the friction torque. Further yet, in response to the rack position estimate being within a predetermined threshold of a measured rack position, the rack position estimate is used as the tire load estimate.

According to one or more embodiments a steering system includes a friction estimate module that computes a friction torque estimate for the steering system. The steering system further includes a control module that computes a motor torque to assist in maneuvering the steering system. The steering system further includes a rack position estimator module that computes a rack position estimate based on the friction torque estimate, the motor torque, and a handwheel torque that is applied by an operator. The steering system further includes an observer module that tunes a gain matrix to minimize an error between the rack position estimate and a measured rack position. The control module uses the rack position estimate as a tire load estimate in response to the error being below a predetermined threshold.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exemplary embodiment of a vehicle including a steering system;

FIG. 2 illustrates example control module according to one or more embodiments;

FIG. 3 illustrates an example plant model of a steering system according to one or more embodiments;

FIG. 4 illustrates one or more components and a data flow of a state observer module, according to one or more embodiments;

FIG. 5 illustrates a block diagram of example modules that facilitate improvements to a power steering system by estimating tire load;

FIG. 6 depicts an example block diagram of a steer by wire system that estimates tire load according to one or more embodiments; and

FIG. 7 depicts a flowchart of estimating a tire load by a steering system without mechanical linkages, such as in a steer by wire system, according to one or more embodiments.

### DETAILED DESCRIPTION

As used herein the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described below can be combined and/or further partitioned.

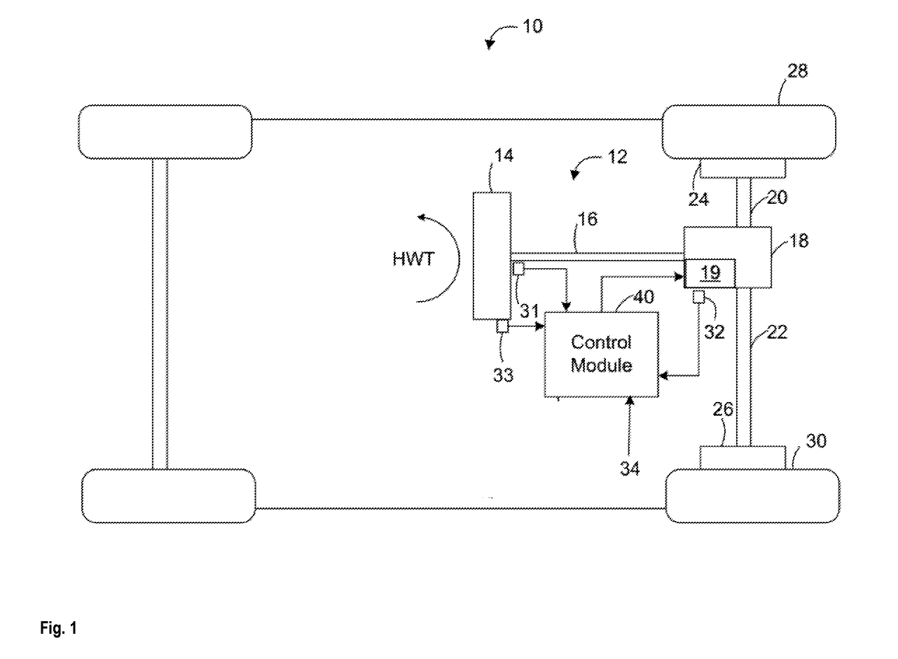

Referring now to the Figures, where the invention will be described with reference to specific embodiments, without limiting same, FIG. 1 is an exemplary embodiment of a vehicle 10 including a steering system 12. In various embodiments, the steering system 12 includes a handwheel 14 coupled to a steering shaft system 16 which includes steering column, intermediate shaft, & the necessary joints. In one exemplary embodiment, the steering system 12 is an EPS system that further includes a steering assist unit 18 that couples to the steering shaft system 16 of the steering system 12, and to tie rods 20, 22 of the vehicle 10. Alternatively, steering assist unit 18 may be coupling the upper portion of the steering shaft system 16 with the lower portion of that system. The steering assist unit 18 includes, for example, a rack and pinion steering mechanism (not shown) that may be coupled through the steering shaft system 16 to a steering actuator motor 19 and gearing. During operation, as a vehicle operator turns the handwheel 14, the steering actuator motor 19 provides the assistance to move the tie rods 20, 22 that in turn moves steering knuckles 24, 26, respectively, coupled to roadway wheels 28, 30, respectively of the vehicle 10.

As shown in FIG. 1, the vehicle 10 further includes various sensors 31, 32, 33 that detect and measure observable conditions of the steering system 12 and/or of the vehicle 10. The sensors 31, 32, 33 generate sensor signals based on the observable conditions. In one example, the sensor 31 is a torque sensor that senses an input driver handwheel torque (HWT) applied to the handwheel 14 by the operator of the vehicle 10. The torque sensor generates a driver torque signal based thereon. In another example, the sensor 32 is a motor angle and speed sensor that senses a rotational angle as well as a rotational speed of the steering actuator motor 19. In yet another example, the sensor 32 is a handwheel position sensor that senses a position of the handwheel 14. The sensor 33 generates a handwheel position signal based thereon.

A control module 40 receives the one or more sensor signals input from sensors 31, 32, 33, and may receive other inputs, such as a vehicle speed signal 34. The control module 40 generates a command signal to control the steering actuator motor 19 of the steering system 12 based on one or more of the inputs and further based on the steering control systems and methods of the present disclosure. The steering control systems and methods of the present disclosure apply signal conditioning and perform friction classification to determine a surface friction, and other estimates as a control signals that can be used to control aspects of the steering system 12 through the steering assist unit 18.

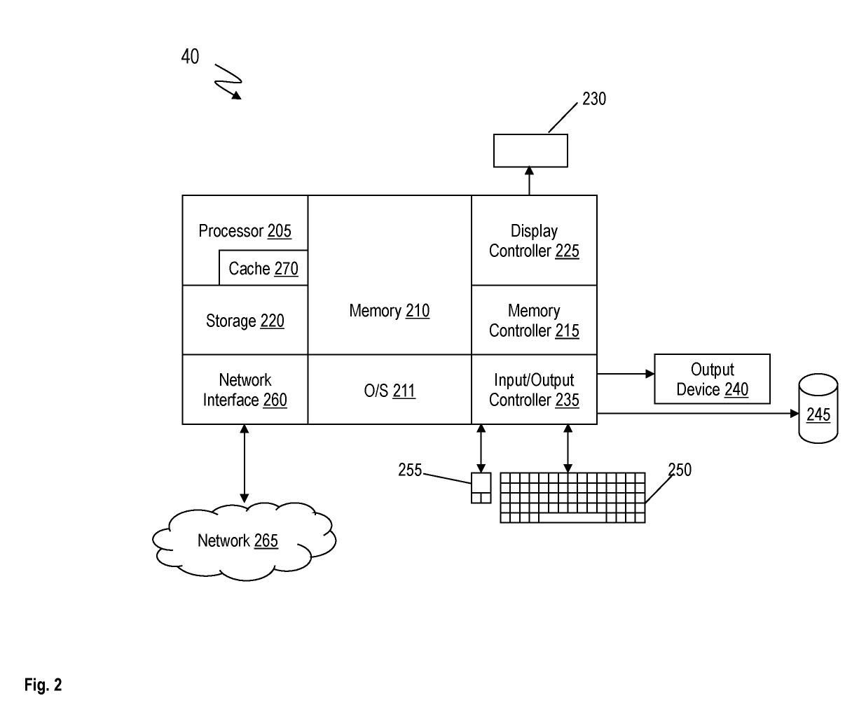

FIG. 2 illustrates example control module 40 according to one or more embodiments. The control module 40 may be an ECU that executes a real time operating system (RTOS).

For example, the control module 40 includes, among other components, a processor 205, memory 210 coupled to a memory controller 215, and one or more input devices 245 and/or output devices 240, such as peripheral or control devices, that are communicatively coupled via a local I/O controller 235. These devices 240 and 245 may include, for example, battery sensors, position sensors (altimeter, accelerometer, GPS), indicator/identification lights and the like. Input devices such as a conventional keyboard 250 and mouse 255 may be coupled to the I/O controller 235. The I/O controller 235 may be, for example, one or more buses or other wired or wireless connections, as are known in the art. The I/O controller 235 may have additional elements, which are omitted for simplicity, such as controllers, buffers (caches), drivers, repeaters, and receivers, to enable communications.

The I/O devices 240, 245 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 205 is a hardware device for executing hardware instructions or software, particularly those stored in memory 210. The processor 205 may be a custom made or commercially available processor, a central processing unit (CPU), an auxiliary processor among several processors associated with the control module 40, a semiconductor based microprocessor (in the form of a microchip or chip set), a macroprocessor, or other device for executing instructions. The processor 205 includes a cache 270, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 may be organized as a hierarchy of more cache levels (L1, L2, and so on.).

The memory 210 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 may incorporate electronic, magnetic, optical, or other types of storage media. Note that the memory 210 may have a distributed architecture, where various components are situated remote from one another but may be accessed by the processor 205.

The instructions in memory 210 may include one or more separate programs, each of which comprises an ordered listing of executable instructions for implementing logical functions. In the example of FIG. 2, the instructions in the memory 210 include a suitable RTOS 211. The RTOS 211 controls the execution of other computer programs and provides scheduling, input-output control, file and data management, memory management, and communication control and related services.

Additional data, including, for example, instructions for the processor 205 or other retrievable information, may be stored in storage 220, which may be a storage device such as a hard disk drive or solid state drive. The stored instructions in memory 210 or in storage 220 may include those enabling the processor to execute one or more aspects of the systems and methods of this disclosure.

The control module 40 may further include a display controller 225 coupled to a user interface or display 230. In some embodiments, the display 230 may be an LCD screen. In other embodiments, the display 230 may include a plurality of LED status lights. In some embodiments, the control module 40 may further include a network interface 260 for coupling to a network 165. The network 165 may be an IP-based network for communication between the control module 40 and an external server, client and the like via a broadband connection. In an embodiment, the network 165 may be a satellite network. The network 165 transmits and receives data between the control module 40 and external systems. In some embodiments, the network 165 may be a managed IP network administered by a service provider. The network 165 may be implemented in a wireless fashion, for example, using wireless protocols and technologies, such as WiFi, WiMax, satellite, or any other. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet, a Controller Area Network (CAN) or other types of vehicle bus networks, or other suitable network system and may include equipment for receiving and transmitting signals.

In one or more examples, the control module 40 implements one or more technical features described herein in the form of computer implemented methods. For example, the computer module 40 accesses the technical features described herein in the form of computer executable instructions on memory that is accessible by the control module 40 to implement the one or more technical features. The logic of such computer implemented features is described herein in the form of one or more flowcharts and other figures.

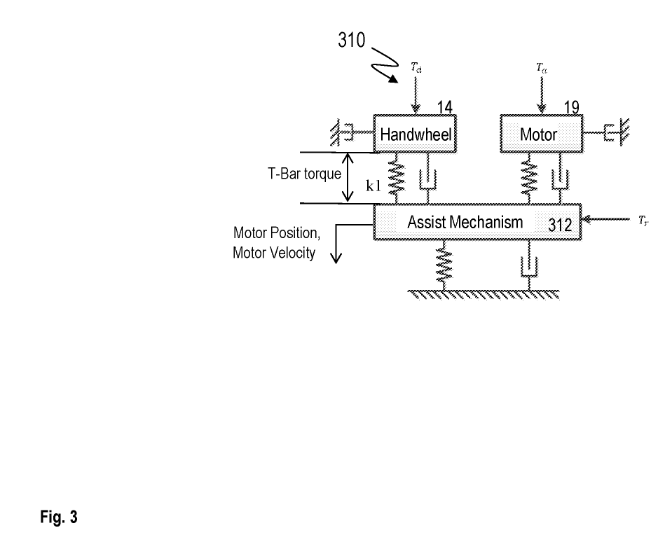

FIG. 3 illustrates example plant model of the steering system 12 according to one or more embodiments. In one or more examples, the state observer module 210 uses a 3-mass plant model 310 of the EPS system 12, which may be described by the following mathematical expressions in continuous time.

\dot{x}=Ax+Bu+Ed

y=Cx

where x is a state vector including values of the current state of the EPS system 12, u is an input vector including measurable (and controllable) inputs to the EPS system 12, and d is a disturbance vector including measurable values that are not controllable, and typically non-linear in nature. Further, y is an output vector that is based on the current state x of the EPS system 12. A, B, C, and E, are configurable matrices which are setup to model the motor 19 of the EPS system 12. In one or more examples, the matrices may be preconfigured. Typically, an observer design is performed by utilizing a model of the plant whose state variable is to be extracted. Because the plant's current outputs and its future state are both determined based on the current states and the current inputs, the output of the plant, y(k) is used to steer the state of the state observer module 210.

In the 3-mass plant model 310, the EPS system 12 experiences a driver torque T_{d}, an assist torque Tₐ, and a rack force or equivalent rack torque Tᵣ. The driver torque represents the force applied by the operator/driver of the vehicle 10 on the handwheel to steer the vehicle 10. The assist torque represents the driver assist torque provided by an assist mechanism 312 of the EPS system 12 to assist the driver to steer the vehicle 10. The rack torque represents forces that make up the road disturbances, tire-road friction etc. In one or more examples, a rack and pinion of the vehicle 10 experience the road disturbances.

The steering rack is linked to the road wheels by tie rods and the drivers input is transferred to the steering rack by the hand wheel and steering column. As can be appreciated, the steering system 12 can be modeled according to various configurations. For example, the steering system 12 can be represented as a linear system model consisting of 2 inertias hand wheel torque (T_{HW}) and assist-mechanism torque (T_{AM}) respectively, where the assist torque Tₐ and the rack torque Tᵣ are combined as the assist-mechanism torque.

As depicted in FIG. 3, the assist torque Tₐ (or motor torque) and driver torque T_{d} represent the 2 inputs to the assist mechanism 312, while T-Bar torque (T_{HW} motor position, and motor velocity, represent the 3 outputs or measurements in the EPS system. T_{HW} is the torque across the torsion spring k1 that connects the handwheel with the assist mechanism (rack and pinon). A torque sensor measures the T-Bar torque (T_{HW}) across the spring k1.

The 2-mass model can be further reduced to 1-mass (JAM) model as both motor torque (Tm) and T-Bar Torque (T_{HW}) can be measured. Accordingly, a physical steering column to convey the road disturbance to the steering system 12 can be replaced by estimating the non-linear forces that make up the tire load. For example, the equations for the 1-mass model taking into consideration non-linear friction (Tf) can written as

J_{AM}\ddot{θ}_{AM}+b\dot{θ}_{AM}=T_{HW}+Tₘ+d−Tf Equation (1)

where J_{AM} is the mass of the assist mechanism 312, b is a predetermined damping coefficient, and θ_{AM} represents motor position of the motor 12 of the steering system 12. In the above equation, T_{f} is an unknown value, because Tm (motor torque) is based on the torque command computed by the control module 40, and d is the rack force. Although d may be measured by a sensor, however such sensors are costly. Accordingly, estimating the value of d saves costs. For example, the amount of motor torque (Tₘ) to be applied is determined by various EPS algorithms and hence Tₘ is a known quantity. The internal motor control loop ensures that the motor torque Tₘ generated by the motor 19 is same as the motor torque command.

The technical solutions described herein facilitate determining the tire load using linear estimation techniques. For facilitating the linear estimation techniques, before application of the linear estimation method, the non-linear friction T_{f} term from the above equation of the steering system 12 has to be addressed. Hence, the technical solutions described herein use a friction compensation module that computes an estimate value (T_{fest}) of the non-linear T_{f}. Once T_{fest} approximates the real friction term (T_{fest}˜T_{f}), which directly acts on the reduced 1 mass J_{AM}, the tire load is determined using values of the other terms in the above equation.

In one or more examples, for determining the T_{fest,} the friction torque T_{f} is modelled as a combination of static friction (α₀+α₁), dry friction α₀, Stribeck friction g(v), and viscous friction (α₂v) between the moving parts, the mounting points and the bearings. For example, the T_{fest} is determined using the following calculations.

$$\frac{dz}{dt} = v - {σ}_{0} \frac{\vert v \vert}{g ( v )} z$$

$$g ( v ) = {α}_{0} + {α}_{1} {e}^{- {( \frac{v}{{v}_{0}} )}^{2}}$$

$${Tf}_{est} = {σ}_{0} z + {σ}_{1} \dot{z} + {α}_{2} v$$

where, z denotes an average bristle deflection, a predetermined value; v represents motor velocity; σ₀ represents stiffness, α₀ is a predetermined couloumb friction, (α₀+α₁) is a predetermined stiction force

Equation (1) can be rewritten using an input torque term Tᵢ, which compensates the non-linear friction part as shown below in Equation (2).

J_{AM}\ddot{θ}_{AM}+b\dot{θ}_{AM}=Tᵢ+d Equation (2)

where Tᵢ=Tₘ+T_{HW}+T_{fest}; and \dot{d}=0

In the rewritten form only the damping (b) and the disturbance or the rack force (d) act on the reduced inertia J_{AM}. All the physical parameters (J_{AM}, b_{AM}) of the 1-mass model are estimated based on a frequency response based system identification and collecting data from the EPS gear. Consequently, the approximated friction T_{fest} is added to the input of the 1-mass system, as described in the equation (2) above.

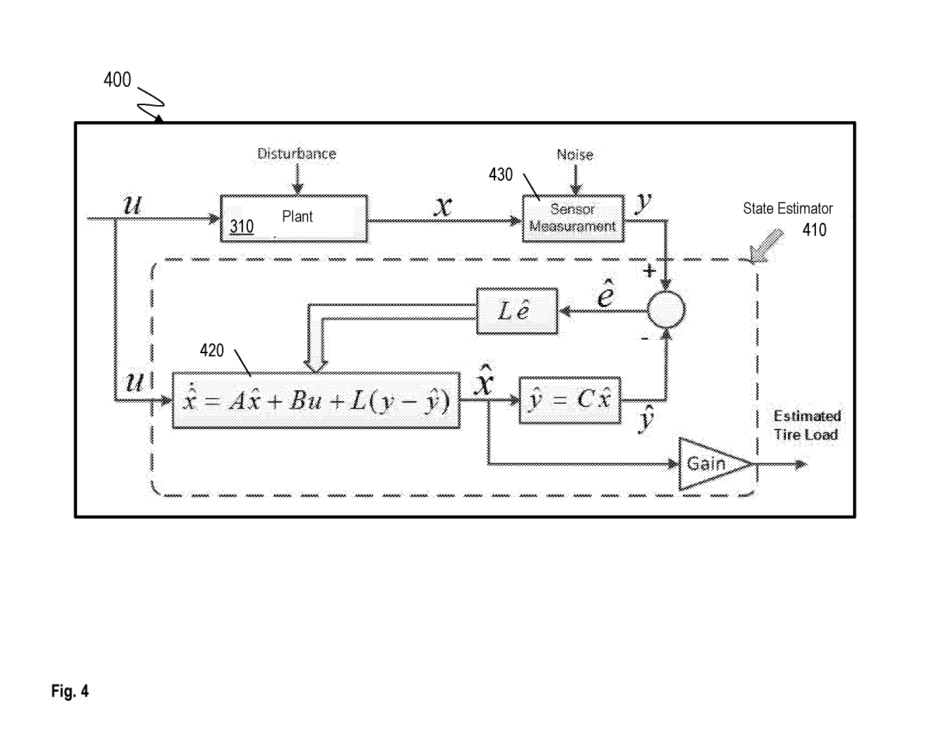

FIG. 4 illustrates one or more components and a data flow of a state observer module for estimating tire load, according to one or more embodiments. The observer module 400 includes a state estimator 410 that computes or estimates one or more state variables of the plant model. An EPS system driver torque (T_{HW}) and motor torque (Tₘ) can be considered as control inputs, while the rack force (d) from the tie-rods acts as external disturbance input. Sensor data, such as a HW angle from sensor 33 and HW torque sensor data from sensor 31 can be preprocessed to produce handwheel angle, handwheel torque and/or driver torque, as well as derivative/delta values, and/or handwheel and vehicle speed.

Further, in one or more examples, motor angle, that is the angle of the motor 19 of the power steering system 12 may be received and converted into roadwheel angle. For example, the motor angle is used to determine a rack position from the motor angle. Further, the rack position is used to determine the roadwheel angle. In one or more examples, the rack position is used with respect to a steering arm length lookup to determine a steer arm length from the rack position. In one or more examples, lookup tables are used to generate the above respective outputs.

Further yet, in one or more examples, the roadwheel angle and a speed of the vehicle 10 are used to determine a front axle force which may be expressed in Newtons, and a front axle slip angle which may be expressed in radians. For example, the front axle force and the front axle slip angle are determined based on a Nonlinear Bicycle Model, or any other such model.

The control module 40 further determines the rack force (d). The rack force represents the one or more forces acting on the rack of the vehicle, such as rolling resistance, air resistance, gradient resistance, and so on. The rack force may depend on the nature of the ground, the tires used, the weight of the vehicle, and the speed of the vehicle, among other factors. In one or more examples, the control module 40 receives the rack force as an input signal from a rack force signal. Alternatively, or in addition, in one or more examples, the control module 40 determines and uses an estimated value of the rack force value as a function of steer arm length, front axle force, front axle slip angle and vehicle speed magnitude that are computed. For example, the rack force estimation may use the following equations to estimate the rack force for any number of given surfaces.

$$m \cdot ( \dot{V} + r \cdot U ) = {F}_{cf} + {F}_{cr} ( Lateral Dynamics )$$

$${I}_{zz} \dot{r} = a \cdot {F}_{cf} - b \cdot {F}_{cr} ( Yaw Dynamics )$$

$${F}_{rack} = ( {t}_{m} + {t}_{p} ) \cdot \frac{{F}_{cf}}{SA} ( Rack Force ) \\ {∝}_{f} = \frac{V + a \cdot r}{U} - {δ}_{lagged} \\ {∝}_{r} = \frac{V - b \cdot r}{U} ,$$

where m is Mass of the vehicle, I_{zz} is Y inertia of the vehicle, SA is steer arm length, a is vehicle CG to Front Axle Distance, b is Vehicle CG to rear axle distance, r is yaw rate, U is longitudinal speed, V is lateral speed, F_{cf} is front axle force, F_{cr} is rear axle force, α_{f} is front axle slip angle, αᵣ is rear axle slip angle, tₘ is mechanical trail, tₚ is pneumatic trail, δ_{lagged} is tire angle with lag, and 0 is motor angle.

As shown in the FIG. 4, the state estimator 410 drives a model 420 of the plant of the EPS 12 using the same control signal input applied to the EPS plant module 310 and updates the state variables of the state estimator 410 until the state estimator outputs are driven to become equal to the measured system outputs. The state estimator module 410 receives the measured system outputs, or intermediate signals, via one or more sensors 430. The estimated state variables may then be used for any purpose within the EPS 12, for example to generate assist torque command, to provide feedback to the driver, and so on. For example, a command is provided for vibrating the handwheel 14 corresponding to the road forces determined. In one or more examples, the state estimator module 310 models the disturbance d 240 as a state variable.

In the depicted model, L is a matrix that includes observer gains, and is modified to achieve desired observer characteristics such as bandwidth. For example, for a linear observer, the gains are scalar values, and act upon a difference of the measured and estimated system outputs. It should be noted however, the present disclosure is not limited to such observers, and other observer structures such as non-linear estimators may also be employed. For instance, a sliding-mode observer may be employed where the state variables are updated on a scalar gain acting on the sign of the output error. Further, a reduced order implementation of the linear and non-linear observers may also be used for estimating the disturbance term and motor velocity.

In order to construct a disturbance model, the disturbance is included as a state of the plant so that the state observer module 410 models the terms \dot{θ}_{AM} and \dot{d} from the equation (2) as states of the EPS 12 and accordingly, the modified plant model may be written as,

$$\begin{matrix}[ \begin{matrix}{\ddot{θ}}_{AM} \\ \dot{d}\end{matrix} ] = [ \begin{matrix}- b / {J}_{Am} & 1 / {J}_{AM} \\ 0 & 0\end{matrix} ] [ \begin{matrix}{\dot{θ}}_{AM} \\ d\end{matrix} ] + [ \begin{matrix}\frac{1}{{J}_{AM}} \\ 0\end{matrix} ] {T}_{i} & Equation ( 5 ) \\ y = [ \begin{matrix}1 & 0\end{matrix} ] [ \begin{matrix}{\dot{θ}}_{AM} \\ d\end{matrix} ] & Equation ( 6 )\end{matrix}$$

Several different gain tuning strategies may be used for obtaining the observer gains, including Linear Quadratic Gaussian (LQG) estimator, pole placement etc. in one or more examples, the matrices A, B, C, and D are configured as follows.

$${A}_{aug} = [ \begin{matrix}- \frac{b}{{J}_{AM}} & \frac{1}{{J}_{AM}} \\ 0 & 0\end{matrix} ]$$

$${B}_{aug} = [ \begin{matrix}\frac{1}{{J}_{AM}} \\ 0\end{matrix} ]$$

$${C}_{aug} = [ \begin{matrix}1 & 0\end{matrix} ]$$

$${D}_{aug} = [ \begin{matrix}0 \\ 0\end{matrix} ]$$

The observer error estimates are given by,

$$\dot{\hat{X}} = {A}_{aug} \hat{X} + {B}_{aug} u + L ( y - \hat{y} )$$

$$\dot{\hat{X}} = {A}_{aug} \hat{X} + {B}_{aug} u + L ( y - {C}_{aug} \hat{X} )$$

$$\dot{\hat{X}} = ( {A}_{aug} - {LC}_{aug} ) \hat{X} + {B}_{aug} u + Ly$$

$$\dot{\hat{X}} = ( {A}_{aug} - {LC}_{aug} ) \hat{X} + [ {B}_{aug} L ] [ \begin{matrix}u \\ y\end{matrix} ]$$

Where u=Tᵢ and y=\dot{θ}_{AM}

A_{obs}=A_{aug}−LC_{aug}

B_{obs}=[B_{aug L]}

The observer matrix L is determined out using LQE (Linear quadratic estimator) or Kalman filter approach by assigning weights on disturbance inputs and noise on measured outputs. For example, the observer module 400 uses steady state Kalman filtering to determine L. The observer module 400 relies on the state-space equation form of the EPS system 12 described above (Equation 1) and a feedback term. The measured output y is compared to the estimated output in order to update the state vector estimate using the feedback term. The feedback term is calculated by multiplying the error term e, with the observer gain, L. L is a matrix that is adjusted to drive the error e to zero, and therefore cause the estimated states to approach the values of the actual states.

The evaluations of the above observer module 400 has provided robust and consistent results of estimated tire load with measured tire loads in various settings with different driving maneuvres at varying speeds. The technical solutions herein thus facilitate determining the tire load estimates with a parameterized observer module and is further based on the friction estimation.

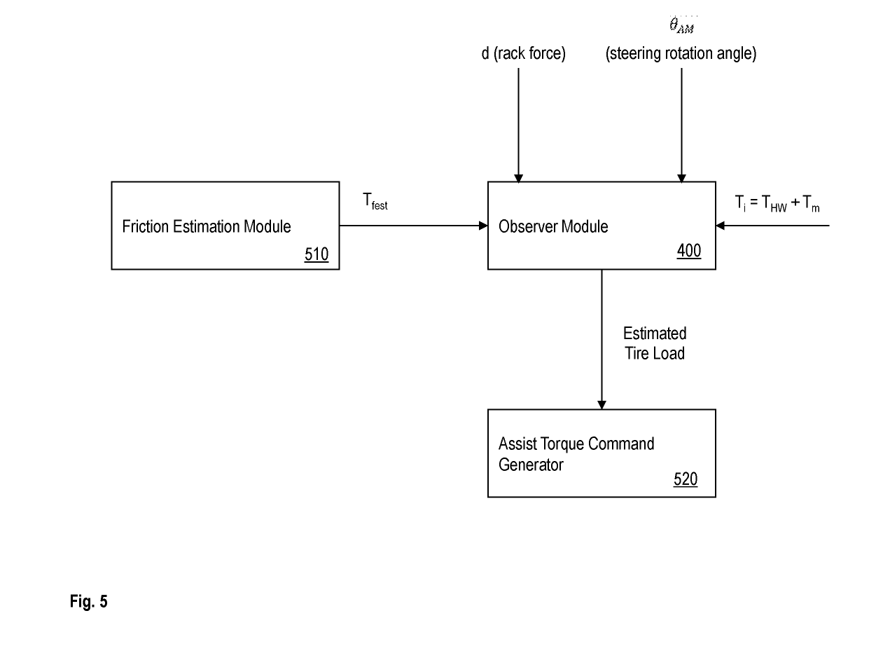

FIG. 5 illustrates a block diagram of example modules that facilitate improvements to the power steering system 12 by estimating tire load. In one or more examples, the one or more modules illustrated are part of the EPS 12. For example, the one or more modules are controlled by the control module 40. A friction estimation module 510 estimates the friction torque (T_{fest}) that is acting on the rack, including the friction from the mechanical components of the rack assembly.

In one or more examples, estimating road surface friction may use wheel slip computed from sensor signals. For example, estimating a change in the road surface friction includes using differences in the wheel velocities and the wheel slip, using vehicle yaw and lateral acceleration sensors, using optical sensors at the front of a vehicle which use reflection from the road surface to estimate the road friction, using acoustic sensors to detect tire noise which gives information about the surface, and using sensors at the tire threads to measure stress and strain which may be referred back to a surface friction.

Alternatively, in one or more examples, the surface friction level is determined using one or more EPS signals. For example, based on the one or more EPS control signals, the control module 40 determines rack force estimates. Further, the control module 40 uses based on the rack force estimates determines a corresponding friction level. In one or more examples, the various ranges of the rack force has corresponding friction values that are used.

The estimated friction torque is input to the observer module 400. The observer module 400 also receives rack force (d). The rack force may be measured by a sensor associated with the rack, or estimated as described herein. The observer module 400 further receives the handwheel angle (θ_{Am}) from a handwheel angle sensor. In addition the observer module 400 receives, as input torque (Tᵢ), which is a sum of the handwheel torque (T_{HW}) and motor torque (Tₘ). The handwheel torque is the amount of force applied by the operator of the vehicle 10 on the handwheel, while the motor torque is the amount of torque supplied by the power steering system as an assistance to aid the operator.

Based on the inputs received, the observer module 400, such as using Kalman filtering, determines an estimate of the tire load acting on the vehicle 10, such as on the rack. The error term between the model 420 provides a value of the estimated tire load, which in one or more examples, is scaled using a predetermined gain (see FIG. 4). The estimated tire load is used by the EPS 12 for one or more applications, such as closed loop torque control, disturbance rejection, and so on.

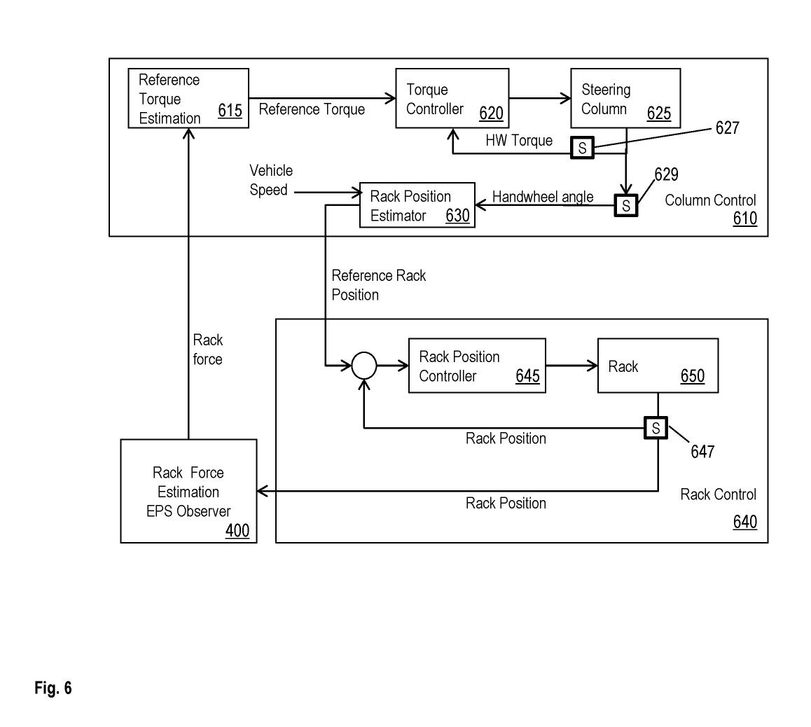

FIG. 6 depicts an example block diagram of a steer by wire system that provides tire load estimate to the steering system 12 according to one or more embodiments. The steering system 12 uses the tire load estimate to provide feedback to the operator of the vehicle 10. Thus, the steering system 12 can provide feedback to the operator without a sensor being used to detect the tire load. It should be noted that FIG. 6 depicts one example implementation of the technical solutions described herein and that other implementations are possible using different, fewer, or additional modules than those depicted.

Referring to FIG. 6, a rack control module 640 controls the rack associated with the tires of the vehicle 10. A column control module 610 controls torque applied to the steering column 625 associated with the steering system 12. The column control module 610 includes an torque controller 620 that generates steering feel torque for the steering column 625. The torque controller 620 generates the steering feel torque, for example as the motor torque (Tₘ). The torque controller 620 generates the steering feel torque based on a torque applied by the operator, that is the handwheel torque (T_{HW}), which can be measured by a sensor 627. In addition, the torque controller 620 receives a reference torque from a reference torque estimation module 615. The reference torque estimation module 615 generates the reference torque based on rack force (d) including/and the tire load.

In one or more examples, such as the steer by wire configuration, the rack and the steering column are not directly connected in a manner to provide direct feedback of the tire load experienced by the rack to the steering column. The technical solutions described herein facilitate communicating one or more parameters from the rack control module 640 to the column control module 610 so that the tire load estimate is accounted for when generating the steering feel torque by the torque controller 620. Based on the torque applied to the steering column 625 and an angle of the steering column 625, a rack position estimator 630 determines an estimate of the rack position. In one or more examples, the rack position estimator 630 further receives a vehicle speed as an input to estimate the rack position.

The rack control module 640 includes a rack position controller module 645 that receives the rack position computed by the rack position estimator module 630. The rack position controller module 645 further receives a current position of the rack as measured by a position sensor 647. Based on the estimated rack position and the current rack position, the rack position controller 645 computes an adjustment for the rack so that the rack 650 is positioned according to the estimated rack position. Further, the rack position is provided to the EPS observer module 400 for the rack force estimation described herein. The computed rack force is then forwarded to the column control module 610 for continuous operation of the steering system 12 as described herein. The rack force estimated includes the tire load that is acting on the rack.

Thus, the EPS observer module 400 estimates the tire load acting on the rack 650, and provides direct road feedback to the operator (driver), without having a physical sensor that measures the tire load. The tracking of estimated tire load is facilitated by the friction estimation module 510, as described herein. The method of rack force prediction is robust to road surface friction and vehicle velocity.

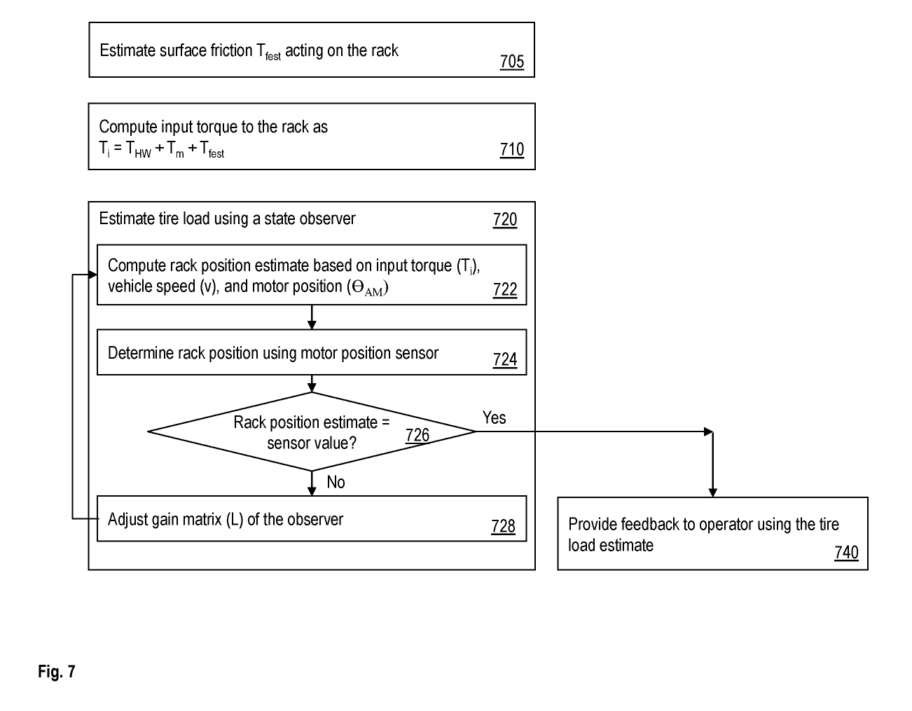

FIG. 7 depicts a flowchart of estimating a tire load by a steering system 12 without mechanical linkages, such as in a steer by wire system, according to one or more embodiments. The method is implemented by the control module 40, in one or more examples. The method includes estimating a system friction T_{fest} acting on the rack of the vehicle 10, as shown at 705. Further, the method includes computing an input torque to the rack as Tᵢ=T_{HW}+Tₘ+T_{fest}, where T_{HW} is the torque applied the operator to the handwheel, Tₘ is the torque provided by the motor 19 as assistance torque, and T_{fest} is the estimated system friction (caused by components of the steering system).

The method further includes using a state observer and techniques such as Kalman filtering to estimate the tire load, as shown at 720. Estimating the tire load includes computing a rack position estimate based on the input torque (Tᵢ), vehicle speed (v), and motor position (θ_{AM}), as shown at 722. The actual rack position is determined using a position sensor, such as the motor position sensor as shown at 724. It should be noted that in one or more examples, a rack position sensor is used instead of the motor position sensor. The estimated rack position is compared with the measured rack position, as shown at 726. If the two values do not match within a predetermined threshold, the method includes adjusting a gain matrix L of the state observer to minimize the error between the estimated and measured rack position values, as shown at 728.

Once the error between the estimated and actual rack position values is within the predetermined threshold, a tire load estimate is computed; for example, the estimated rack position value is used as the tire load. In one or more examples, the estimated rack position value is scaled using a predetermined value to compute the tire load, for example in a different unit. The tire load is further used by the steering system to provide a direct feedback to the operator of the vehicle 10, as shown at 740. In one or more examples, the tire load estimate is used for other applications by the steering system 12, such as computing and providing assist torque.

The technical solutions described herein thus facilitate a steer by wire steering system, which uses an EPS observer to estimate tire load without mechanical linkages. The technical solutions thus facilitate providing steering control of a vehicle with fewer mechanical components/linkages between the steering wheel and the tires/rack, the control of the tires' direction being established through electric motor(s) that are actuated by a controller monitoring control signals at the handwheel from the operator.

The present technical solutions may be a system, a method, and/or a computer program product at any possible technical detail level of integration. The computer program product may include a computer readable storage medium (or media) having computer readable program instructions thereon for causing a processor to carry out aspects of the present technical solutions.

Aspects of the present technical solutions are described herein with reference to flowchart illustrations and/or block diagrams of methods, apparatus (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present technical solutions. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession, in fact, may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Such computer storage media may be part of the device or accessible or connectable thereto. Any application or module herein described may be implemented using computer readable/executable instructions that may be stored or otherwise held by such computer readable media.

While the technical solutions are described in detail in connection with only a limited number of embodiments, it should be readily understood that the technical solutions are not limited to such disclosed embodiments. Rather, the technical solutions can be modified to incorporate any number of variations, alterations, substitutions, or equivalent arrangements not heretofore described, but which are commensurate with the spirit and scope of the technical solutions. Additionally, while various embodiments of the technical solutions have been described, it is to be understood that aspects of the technical solutions may include only some of the described embodiments. Accordingly, the technical solutions are not to be seen as limited by the foregoing description.

What is claimed is:

1. A control system for a power steering system of a vehicle, comprising:
a control module operable to receive sensor data and control the power steering system, the control module configured to:
determine an estimated friction torque of a rack associated with the steering system;
compute an input torque to the rack, the input torque being a sum of the estimated friction torque, a handwheel torque, and a motor torque;
determine a rack position estimate based on the input torque, a handwheel angle, and a vehicle speed; and
in response to the rack position estimate being within a predetermined threshold of a measured rack position, use as a tire load estimate the rack position estimate.

2. The control system of claim 1, the control module further configured to provide feedback to an operator based on the estimated tire load.

3. The control system of claim 1, wherein the tire load estimate is a measured state of a plant model of the steering system.

4. The control system of claim 1, wherein in response to the rack position estimate not being within the predetermined threshold of the measured rack position, adjusting a gain matrix of an observer module.

5. The control system of claim 1, wherein the estimated friction torque comprises static friction, dry friction, Stribeck friction, and viscous friction between moving parts, mounting points, and bearings, of the steering system.

6. The control system of claim 1, wherein the power steering system is a steer by wire type steering system.

7. A computer-implemented method for determining a tire load estimate by a steering system of a vehicle, the method comprising:
receiving, by a control module, a handwheel torque from an operator of the steering system;
computing, by the control module, a motor torque to assist in overcoming an estimated rack force;
computing, by the control module, a friction torque estimate for the steering system;
computing, by the control module, a rack position estimate based on a sum of the handwheel torque, the motor torque, and the friction torque; and
in response to the rack position estimate being within a predetermined threshold of a measured rack position, using the rack position estimate as the tire load estimate.

8. The computer-implemented method of claim 7, further comprising:
using a state observer, by the control module, to compare the rack position estimate with the measured rack position, and in response to the rack position estimate not being within the predetermined threshold of the measured rack position, adjusting a gain matrix of the state observer.

9. The computer-implemented method of claim 8, wherein the tire load estimate is a measured state of a plant model of the steering system used by the state observer.

10. The computer-implemented method of claim 7, further comprising: using the estimated tire load to determine the motor torque.

11. The computer-implemented method of claim 7, further comprising: providing feedback to an operator based on the estimated tire load.

12. The computer-implemented method of claim 7, wherein the friction torque estimate comprises static friction, dry friction, Stribeck friction, and viscous friction between moving parts, mounting points, and bearings, of the steering system.

13. The computer-implemented method of claim 7, wherein the steering system is a steer by wire type steering system, without a mechanical linkage between a rack and the steering system.

14. A steering system comprising:
a friction estimate module configured to compute a friction torque estimate for the steering system;
a control module configured to compute a motor torque to assist in maneuvering the steering system;
a rack position estimator module configured to compute a rack position estimate based on the friction torque estimate, the motor torque, and a handwheel torque that is applied by an operator; and
an observer module configured to tune a gain matrix to minimize an error between the rack position estimate and a measured rack position;
wherein, the control module is further configured to use the rack position estimate as a tire load estimate in response to the error being below a predetermined threshold.

15. The steering system of claim 14, wherein the observer module is further configured to:
compare the rack position estimate with the measured rack position; and
in response to the rack position estimate not being within the predetermined threshold of the measured rack position, adjust the gain matrix of the observer module.

16. The steering system of claim 15, wherein the tire load estimate is a measured state of a plant model of the steering system used by the observer module.

17. The steering system of claim 14, wherein the estimated tire load is used to determine the motor torque.

18. The steering system of claim 14, the control module is further configured to provide feedback to an operator of the steering system based on the tire load estimate.

19. The steering system of claim 14, wherein the friction torque estimate comprises static friction, dry friction, Stribeck friction, and viscous friction between moving parts, mounting points, and bearings, of the steering system.

20. The steering system of claim 14, wherein the steering system is a steer by wire type steering system, without a mechanical linkage between a rack and the steering system.
